(19) United States
(12) Patent Application Publication
(10) Pub. No.: US 2023/0346644 A1
(43) Pub. Date: Nov. 2, 2023

(54) MEDICINE BOTTLE FOR SEPARATELY CONTAINING, PREPARING, AND DELIVERING SOLID AND LIQUID MEDICINE

(71) Applicant: ZHAOKE(GUANGZHOU) OPHTHALMOLOGY PHARMACEUTICAL LIMITED, Guangzhou (CN)

(72) Inventors: Xiangrong DAI, Guangzhou (CN); Xiaoyi LI, Guangzhou (CN); Lei YIN, Guangzhou (CN); Yifan DU, Guangzhou (CN)

(73) Assignee: ZHAOKE (GUANGZHOU) OPHTHALMOLOGY PHARMACEUTICAL LIMITED, Guangzhou (CN)

(21) Appl. No.: 17/768,226

(22) PCT Filed: Dec. 19, 2019
(86) PCT No.: PCT/CN2019/126606

§ 371 Date: Apr. 12, 2022

(30) Foreign Application Priority Data
Jul. 17, 2019 (CN) 201910644986.9
Jul. 17, 2019 (CN) 201921121986.2

(51) Int. Cl. A61J 1/20; A61J 7/00

(52) U.S. Cl. CPC A61J 1/2093; A61J 7/0084

(57) ABSTRACT

A medicine bottle for separately containing, preparing, and delivering solid and liquid medicine includes a bottle body, a first sealing separator, a second sealing separator, a sliding penetration rod, and a protective structure. The first sealing separator and the second sealing separator are separately sealed and arranged inside the bottle body to separate a compartment of the bottle body into upper, middle, and lower chambers. The sliding penetration rod is arranged inside the upper chamber of the bottle body as a cylinder in clearance fit with an inner wall of the bottle body, forming piston-like connection allowing for relative sliding. The sliding penetration rod has a through hole inside and a length greater than a sum of lengths of the upper and lower chambers of the bottle body. The protective structure is cup-shaped and fastened upside-down on a top of the bottle body to protect the sliding penetration rod.

### TECHNICAL FIELD

The technical solution of the present disclosure belongs to the technical field of medical supplies and devices, and in particular, relates to a medicine bottle for separating solid and liquid medicine, that is, a medicine bottle for separately containing, preparing, and delivering solid and liquid medicine.

### BACKGROUND

During the preparation and use of medicine, chemical properties of liquid medicine are not stable. Therefore, the liquid medicine is prone to hydrolysis during use and storage for a long period of time, resulting in problems such as decreased content and increased impurities caused by degradation during the shelf life, which increases the risk of patient medication. Therefore, the water-soluble liquid medicine is made in a form of “solid medicinal agent+solvent”, namely, the solid medicinal agent and the solvent are stored separately before use, and then mixed, prepared, and administered for immediate use. In this way, the storage stability of the medicine is greatly improved, and the service life of the medicine is prolonged.

At present, multi-dose accommodating bottles have been designed to store solid medicine and solvents separately, such as rifampicin eye drops bottles. Specifically, the medicine is made into powder, and then a separate bottle of solvent is used as a solvent for the medicine. Before use, the medicinal powder is added to the solvent according to the prescribed amount, and mixed well for dissolution to prepare eye drops, and then administered. Although this traditional container form of “solid medicinal agent+solvent” reduces medicine hydrolysis during storage to a certain extent and prolongs the validity period of the medicine, for patients, operation steps required in actual clinical use are extremely cumbersome. At the same time, it is difficult to ensure its sterility during preparation and use, which leads to the possibility of potential contamination in the preparation of medicine, thereby increasing the risk of patient medication.

To sum up, it is imperative to design a new drug delivery system suitable for preparation and delivery of “solid medicinal agent+solvent” medicine for immediate use, which is convenient for patients and reduces the risk of medicine contamination in the mixing and preparation process, based on the traditional concept of “solid medicinal agent+solvent” medicine container.

### SUMMARY

Therefore, embodiments of the present disclosure provide a medicine bottle for separately containing, preparing, and delivering solid and liquid medicine, so as to solve the problem in the prior art that a traditional “solid medicinal agent+solvent” medicine container is not easy to operate and is easy to cause potential medicine contamination during operation.

To achieve the above objective, the present disclosure adopts the following technical solutions: a medicine bottle for separately containing, preparing, and delivering solid and liquid medicine includes a bottle body, a sealing separator A, a sealing separator B, a sliding penetration rod, and a protective structure. The bottle body is of a bottle-shaped container structure, and is used to store medicine, connect the sliding penetration rod in clearance fit, and carry the protective structure. The sealing separator A and the sealing separator B are separately sealed and arranged inside the bottle body, and separate a compartment of the bottle body into an upper, middle, and lower chamber. The upper chamber of the bottle body is a cylinder with the same inner diameter up and down, the sliding penetration rod is arranged inside the upper chamber, and the sliding penetration rod is a cylinder and is clearance fit with an inner wall of the bottle body, forming piston-like connection allowing for relative sliding. The sliding penetration rod has a length greater than a sum of lengths of the upper and lower chambers of the bottle body, and a through hole is formed in the sliding penetration rod through top and bottom. The protective structure as a whole is cup-shaped, is fastened upside-down on a top of the bottle body, and forms fixed connection with the bottle body to protect the sliding penetration rod.

Further, the middle and lower chambers of the bottle body may be of a cylindrical structure with a same inner diameter as that of the upper chamber of the bottle body.

Further, a pointed protruding structure may be arranged at a bottom of the cylinder of the sliding penetration rod.

Further, a stop structure may be arranged at a top or upper part of the cylinder of the sliding penetration rod.

Further, the protective structure may be a cup-shaped round cover covering the top of the bottle body to protect the sliding penetration rod, and the round cover may form fixed connection with an external thread or clamping table on the bottle body through an internal thread or clamping table.

Further, the protective structure may consist of a cup-shaped gland and a ring-shaped baffle member, the ring-shaped baffle member may be detachably mounted around an outer surface of the bottle body, and the gland may cover the top of the bottle body to protect the sliding penetration rod, and may be detachably and fixedly mounted on the ring-shaped baffle member.

Further, a number of the sealing separator A and a number of the sealing separator B are at least one, respectively, the sealing separator A is made of a fragile single-piece body, and the sealing separator B is made of metal or plastic.

The medicine bottle for separately containing, preparing, and delivering solid and liquid medicine provided by the preset disclosure can realize separation and storage of the solid agent and solvent, improves the stability of medicine storage, avoids hand contact in preparation and use, is simple, convenient, and quick to operate, and avoids the risk of bacterial contamination caused by manual preparation of medicinal liquid.

### BRIEF DESCRIPTION OF THE DRAWINGS

FIG. 1 is a schematic structural diagram of a medicine bottle for separately containing, preparing, and delivering solid and liquid medicine according to Embodiment I of the present disclosure; and

FIG. 2 is a schematic structural diagram of a medicine bottle for separately containing, preparing, and delivering solid and liquid medicine according to Embodiment II of the present disclosure.

In the figures: 1, a bottle body; 2, a sealing separator A; 3, a sealing separator B; 4, a sliding penetration rod; 5, a protective structure; 6, a gland; 7, a ring-shaped baffle member; 8, a tip; and 9, a stop structure.

### DETAILED DESCRIPTION OF THE EMBODIMENTS

To make the objective, technical solutions, and advantages of the present disclosure clearer, the present disclosure will be further described in detail below with reference to the accompanying drawings and embodiments. It should be understood that the specific embodiments described herein are merely intended to explain the present disclosure, rather than to limit the present disclosure.

### Embodiment I

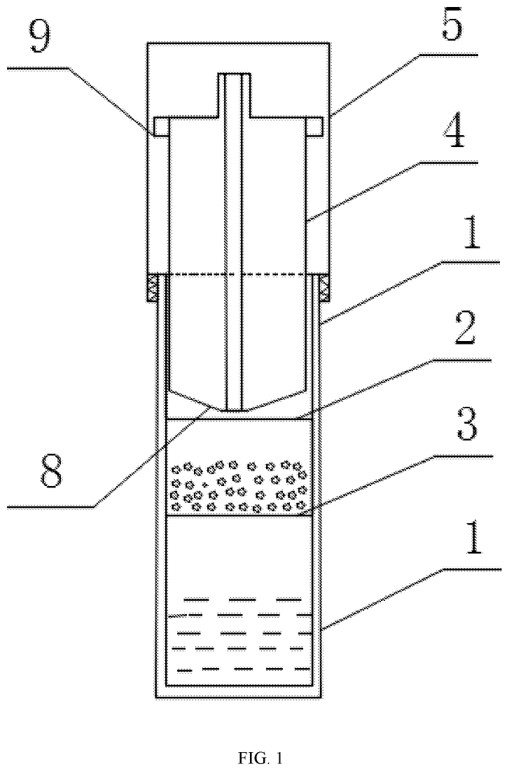

Embodiment I provides a medicine bottle for separately containing, preparing, and delivering solid and liquid medicine. As shown in FIG. 1, a bottle body 1 is of a bottle-shaped container structure straight up and down. A sealing separator A 2 and a sealing separator B 3 are separately sealed and arranged inside the bottle body 1, and separate a compartment of the bottle body 1 into an upper, middle, and lower chamber. The lower chamber is used to store liquid-state medicine, and the middle chamber is used to store solid-state medicine. A sliding penetration rod 4 is arranged inside the bottle body 1, and the sliding penetration rod 4 is a cylinder, is located at the upper chamber of the bottle body 1, and is in clearance fit with an inner wall of the bottle body 1, forming piston-like connection allowing for relative sliding. The sliding penetration rod 4 has a length greater than a sum of lengths of the upper and middle chambers of the bottle body 1. In this way, during use, the top of the sliding penetration rod 4 is pushed artificially, the bottom of the sliding penetration rod 4 will break through the sealing separator A 2 and the sealing separator B 3, and the bottom of the sliding penetration rod 4 can penetrate deep into the lower chamber of the bottle body 1. At this time, the upper, middle, and lower chambers of the bottle body 1 form a medicinal liquid chamber, and the solid-state medicine and the liquid-state medicinal agent are mixed together to form the prepared medicinal liquid.

The bottom of the sliding penetration rod 4 is an inverted V-shaped tip 8, the sealing separator A is made of a fragile single-piece body, and the sealing separator B is made of thin plastic, such that the sliding penetration rod 4 penetrates the sealing separator A 2 and the sealing separator B 3 more easily and the operating experience will be better. A protruding stop structure 9 is arranged around an upper part of the sliding penetration rod 4. When the top of the sliding penetration rod 4 is pushed artificially, the stop structure 9 will make the sliding penetration rod 4 stuck in the bottle body 1 to avoid being pushed into the bottle body 1. A through hole is formed in the sliding penetration rod 4 through top and bottom, and when the medicinal liquid is delivered, the prepared medicinal liquid will flow out along the through hole for use. A protective structure of the medicine bottle for separately containing, preparing, and delivering solid and liquid medicine provided by Embodiment I is an independent round cover 5, is fastened upside-down on the top of the bottle body 1, and forms fixed connection with the bottle body 1 in the form of internal and external threads to protect the sliding penetration rod 4, and the round cover 5 can also be fixedly connected by other forms such as a clamping table and a buckle. The operation of the present embodiment is simple, and in the whole process of separately containing, preparing, and delivering solid-state and liquid-state medicine, there is no contact with the outside world, which not only prolongs the effective storage period of the medicine, but also facilitates the operation and use of users. When the medicinal liquid cannot be used at one time and needs to be used for many times, the use of the medicine bottle is very sanitary and convenient.

### Embodiment II

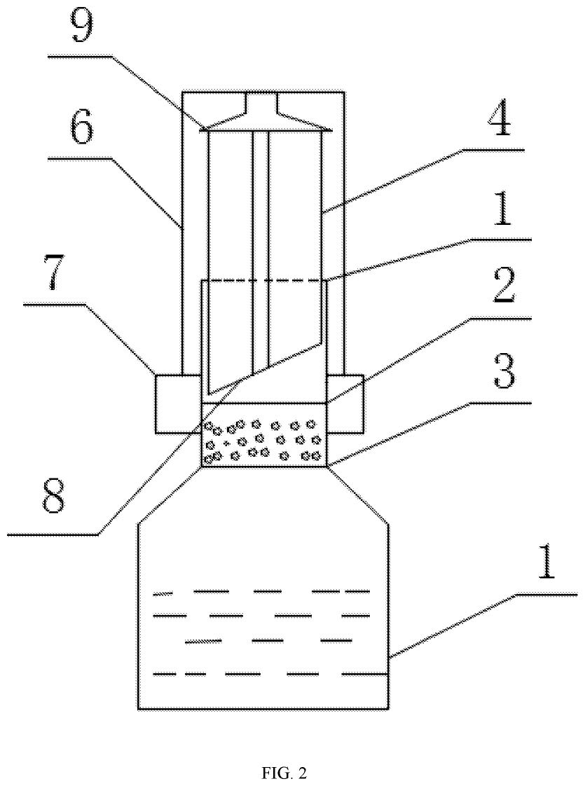

Embodiment II provides a medicine bottle for separately containing, preparing, and delivering solid and liquid medicine. As shown in FIG. 2, a bottle body 1 is not of an integral bottle-shaped container structure straight up and down. A sealing separator A 2 and a sealing separator B 3 are separately sealed and arranged inside the bottle body 1, and separate a compartment of the bottle body 1 into an upper, middle, and lower chamber. The lower chamber is used to store liquid-state medicine, and the middle chamber is used to store solid-state medicine. Only the upper and middle chambers of the bottle body 1 are of a cylindrical structure straight up and down. A sliding penetration rod 4 is arranged inside the upper chamber of the bottle body 1, and the sliding penetration rod 4 is a cylinder, and is in clearance fit with an inner wall of the bottle body 1, forming piston-like connection allowing for relative sliding. The sliding penetration rod 4 has a length greater than a sum of lengths of the upper and middle chambers of the bottle body 1. In this way, during use, the top of the sliding penetration rod 4 is pushed artificially, the bottom of the sliding penetration rod 4 will break through the sealing separator A 2 and the sealing separator B 3, and the bottom of the sliding penetration rod 4 can penetrate deep into the lower chamber of the bottle body 1. At this time, the upper, middle, and lower chambers of the bottle body 1 form a medicinal liquid chamber, and the solid-state medicine and the liquid-state medicinal agent are mixed together to form the prepared medicinal liquid.

In Embodiment II, the bottom of the sliding penetration rod 4 is an oblique-triangle-shaped tip 8, and the sealing separator B is made of thin metal, such that the sliding penetration rod 4 penetrates the sealing separator A 2 and the sealing separator B 3 more easily and the operating experience will be better. The top of the sliding penetration rod 4 is designed as a stop structure 9 with an umbrella structure. When the top of the sliding penetration rod 4 is pushed artificially, the pressing feeling of the user will be better, the stop structure 9 will make the sliding penetration rod 4 stuck in the bottle body 1 to prevent the sliding penetration rod 4 from being pushed into the bottle body 1. A through hole is formed in the sliding penetration rod 4 through top and bottom, and when the medicinal liquid is delivered, the prepared medicinal liquid will flow out along the through hole for use. A protective structure of the medicine bottle for separately containing, preparing, and delivering solid and liquid medicine provided by Embodiment II consists of a gland 6 and a ring-shaped baffle member 7, the ring-shaped baffle member 7 is detachably mounted around an outer surface of the bottle body 1, and the gland 6 covers the top of the bottle body 1 to protect the sliding penetration rod 4, and is detachably and fixedly mounted on the ring-shaped baffle member 7. During use, the ring-shaped baffle member 7 can be disassembled manually, a connecting part of the ring-shaped baffle member 7 with the bottle body 1 and the gland 6 will break, and the gland 6 can be easily removed. The operation of the present embodiment is simple, and in the whole process of separately containing, preparing, and delivering solid-state and liquid-state medicine, there is no contact with the outside world, which not only prolongs the effective storage period of the medicine, but also facilitates the operation and use of users. When the medicinal liquid can be used at one time, the use of the medicine bottle in Embodiment II is more economic, sanitary and convenient.

The medicine bottle for separately containing, preparing, and delivering solid and liquid medicine in the present disclosure can be used for preparation and delivery of a final product (OP), namely eye drops, including medicine that can be placed in solid-liquid separation, and can be prepared and delivered for use, such as atropine eye drops, epinastine eye drops, bimatoprost eye drops liquid, povidone-iodine eye drops, timolol eye drops, latanoprost eye drops, cyclosporine eye drops, levobetaxolol eye drops, thymosin beta 4 eye drops, germinal peptide eye drops, rebamipide eye drops, proparacaine eye drops, chloramphenicol eye drops, moxifloxacin eye drops, and brinzolamide eye drops, and not limited to the eye drops.

The medicine bottle for separately containing, preparing, and delivering solid and liquid medicine provided by the present disclosure may only include a sealing separator A or a sealing separator B. The bottle body is divided into upper and lower chambers by a sealing separator A or B, and the upper chamber is used to store medicine and a sliding penetration rod is arranged inside the upper chamber.

Although the present disclosure has been described in detail above with general descriptions and specific embodiments, some modifications or improvements can be made on the basis of the present disclosure, which is apparent to those skilled in the art. Therefore, all these modifications or improvements made without departing from the spirit of the present disclosure fall within the claimed scope of the present disclosure.

What is claimed is:

1. A medicine bottle for separately containing, preparing, and delivering solid and liquid medicine, comprising: a bottle body, a first sealing separator, a second sealing separator, a sliding penetration rod, and a protective structure;
wherein the bottle body is of a bottle-shaped container structure, and is used to store medicine, connect the sliding penetration rod in clearance fit, and carry the protective structure;
the first sealing separator and the second sealing separator are separately sealed and arranged inside the bottle body, and the first sealing separator and the second sealing separator separate a compartment of the bottle body into an upper chamber, a middle chamber, and a lower chamber;
the upper chamber of the bottle body is a cylinder with a same inner diameter up and down, the sliding penetration rod is arranged inside the upper chamber, and the sliding penetration rod is a cylinder and in clearance fit with an inner wall of the bottle body, forming a piston-like connection allowing for relative sliding;
the sliding penetration rod has a length greater than a sum of a length of the upper chamber and a length of the lower chamber of the bottle body, and a through hole is formed in the sliding penetration rod through top and bottom; and
the protective structure as a whole is cup-shaped, is fastened upside-down on a top of the bottle body, and forms a fixed connection with the bottle body to protect the sliding penetration rod.

2. The medicine bottle according to claim 1, wherein the middle chamber and the lower chamber of the bottle body are of a cylindrical structure with an inner diameter equal to the inner diameter of the upper chamber of the bottle body.

3. The medicine bottle according to claim 1, wherein a pointed protruding structure is arranged at a bottom of the cylinder of the sliding penetration rod.

4. The medicine bottle according to claim 1, wherein a stop structure is arranged at a top or upper part of the cylinder of the sliding penetration rod.

5. The medicine bottle according to claim 1, wherein the protective structure is a cup-shaped round cover covering the top of the bottle body to protect the sliding penetration rod, and the cup-shaped round cover forms a fixed connection with an external thread or clamping table on the bottle body through an internal thread or clamping table of the cup-shaped round cover.

6. The medicine bottle according to claim 1, wherein the protective structure comprises a cup-shaped gland and a ring-shaped baffle member, the ring-shaped baffle member is detachably mounted around an outer surface of the bottle body, and the cup-shaped gland covers the top of the bottle body to protect the sliding penetration rod, and is detachably and fixedly mounted on the ring-shaped baffle member.

7. The medicine bottle according to claim 1, wherein a number of the first sealing separator and a number of the second sealing separator are at least one, respectively, the first sealing separator is made of a fragile single-piece body, and the second sealing separator is made of metal or plastic.
